(19) United States
(12) Patent Application Publication
(10) Pub. No.: US 2003/0152070 A1
(43) Pub. Date: Aug. 14, 2003

(54) Method for transmitting signaling messages between first and second network units, and radio communication system and base station subsystem therefor

(75) Inventor: Karl Fuchs, Furth (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/357,505

(22) Filed: Feb. 4, 2003

(30) Foreign Application Priority Data
Feb. 4, 2002 (DE) 102 04 410.4
Feb. 5, 2002 (EP) 020 02 586.2

(51) Int. Cl. H04L 12/50

(52) U.S. Cl. 370/373

(57) ABSTRACT

In a communication system having a first network unit and a second network unit, a plurality of subscriber units which transmit and receive signaling messages to the second network unit are provided in the first network unit. The signaling messages of the subscriber units are in each case divided into a first class of signaling messages and into a second class of signaling messages. The signaling messages are transmitted between the first network unit and the second network unit via a common link. In the case where a measured utilization of the common link exceeds a first threshold, the transmission of signaling messages assigned to the second class is interrupted for all subscriber units. In the case where the measured utilization of the common link drops below the first threshold and exceeds a second threshold which is lower than the first threshold, the transmission of signaling messages assigned to the second class can be interrupted for some subscriber units.

### CROSS REFERENCE TO RELATED APPLICATIONS

This application is based on and hereby claims priority to German Application No. 102 04 410.4 filed on Feb. 4, 2002 and European Application No. 020 02 586.2 filed on Feb. 5, 2002, the contents of which are hereby incorporated by reference.

### BACKGROUND OF THE INVENTION

In a communication system having a plurality of network units, signaling messages are exchanged between individual network units. The signaling messages comprise more important signaling messages which are absolutely necessary for the continuation of a communication link that is set up, and less important signaling messages which are not absolutely necessary for the continuation of the communications link. An example of such a communication system is a radio communication system according to the GSM standard such as is known, for example, from B. Walke, Mobilfunknetze und ihre Protokolle (mobile radio networks and their protocols), Teubner-Verlag 1998, page 139 to 151. This radio communication system comprises a multiplicity of base transceiver stations via which radio links to mobile stations are set up via an air interface. Each base transceiver station is associated with a base station controller which is connected to a mobile switching center via which communication links within the radio communication system or to a landline network are implemented. An operations and maintenance center controls the functions of the base station controller and of the base transceiver station. The interface between the base transceiver station and the base station controller is called the A_{bis} interface and is in most cases implemented as a PCM link with a transmission rate of 64 kbit/s.

In the base transceiver station, a plurality of subscriber units are provided which are constructed as transceivers and via which the connection to the respective mobile station is implemented. The signaling messages are transmitted and received by the subscriber units.

In the base transceiver station, a processor is additionally provided which, among other things, controls the transmitting and receiving of the signaling messages via the link between the base transceiver station and the base station controller.

As the number of subscriber units per base transceiver station increases, the utilization of the link between the base transceiver station and the base station controller with signaling messages thus increases. Furthermore, the utilization of the processor increases. Thus, the capacity of the link between base transceiver station and base station controller and of the processor becomes the limiting element with respect to the number of links which are simultaneously possible.

### SUMMARY OF THE INVENTION

One aspect of the invention is based on the problem of specifying a method for transmitting signaling messages between a first network unit and a second network unit of a communication system, in which overloading of the link between the first network unit and the second network unit is avoided.

The proposed method for transmitting signaling messages between a first network unit and a second network unit of a communication system is particularly suitable for application in a radio communication system comprising a base transceiver station and a base station controller for transmitting the signaling messages between the base transceiver station and the base station controller. The radio communication system can be of arbitrary configuration. In particular, the method can be used in radio communication systems according to the second mobile radio generation and the third mobile radio generation. In addition, the method can be used in all communication systems in which signaling messages must be transmitted between a first network unit and a second network unit.

In the first network unit, a plurality of subscriber units are provided which transmit and receive signaling messages. The signaling messages of the subscriber units are in each case divided into a first class of signaling messages and into a second class of signaling messages. To the first class are suitably assigned signaling messages which are more important for a communication link than the signaling messages assigned to the second class. The signaling messages are transmitted via a common link between the first network unit and the second network unit. Utilization of the common link is measured, for example, at a processor which controls the common link. In the case where the measured utilization of the common link exceeds a first threshold, the transmission of signaling messages assigned to the second class is interrupted for all subscriber units. This reduces the current utilization of the link. It ensures that signaling messages which are important for the communication links and which are assigned to the first class can continue to be transmitted.

The utilization may be measured at a processor of the first network unit which controls the link between the first network unit and the second network unit. To free the measurement result of random fluctuations, the measurement is done preferably via a predetermined time interval.

With regard to good utilization coupled with stable operation, it is advantageous, in the case where the measured utilization of the common link drops below the first threshold and exceeds a second threshold which is lower than the first threshold, to interrupt the transmission of signaling messages assigned to the second class for some subscriber units. This only reduces the utilization of the common link to the extent required for preventing an overload situation. This ensures that both signaling messages which are assigned to the first class and signaling messages which are assigned to the second class are transmitted for the largest possible number of communication links.

According to one aspect, the method predetermines the subscriber units for which the transmission of signaling messages assigned to the second class is interrupted when the second threshold is exceeded. This predetermination can be done, for example, in the operations and maintenance center in a radio communication system. As a result, subscribers can be prioritized for whom the transmission both of signaling messages assigned to the first class and of signaling messages assigned to the second class is to be ensured.

If a transgression of the second threshold by the measured utilization is found, the transmission of signaling messages assigned to the second class may be interrupted progressively for individual subscriber units until the measured utilization plus an estimated utilization for the transmission of signaling messages assigned to the second class drops below the second threshold. As a result, a stable state is rapidly achieved in which a certain safety margin from the second threshold is set for the current utilization.

In the case where the measured utilization drops below the second threshold, transmission of signaling messages assigned to the second class may be permitted for some subscriber units for which the transmission of signaling messages assigned to the second class is interrupted. In this manner, the system is operated with optimum utilization.

When the utilization drops below the second threshold, one aspect determines the number of subscriber units for which the transmission of signaling messages assigned to the second class is permitted in dependence on the margin between the second threshold and the measured utilization.

The signaling messages of the second class may be signaling messages for measuring procedures.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a section of a radio communication system,

FIG. 2 shows a diagrammatic flow chart of the method according to one aspect of the invention,

FIGS. 3A and 3B show an algorithm for the method according to one aspect of the invention,

FIG. 4 and FIG. 5 show measured utilizations of a processor as a function of time for various parameters.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

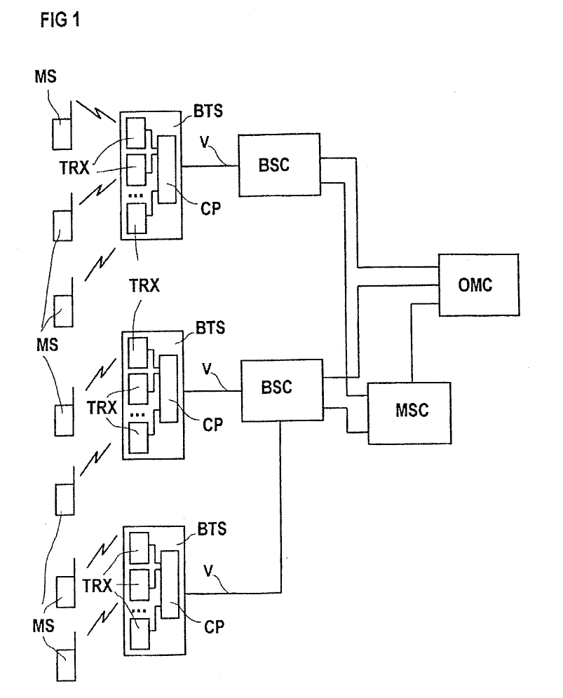

A radio communication system comprises a plurality of base transceiver stations BTS (see FIG. 1). Each of the base transceiver stations BTS is associated with a base station controller BSC. The interface between base transceiver station BTS and base station controller BSC is called the A_{bis} interface.

Each of the base transceiver stations BTS comprises a plurality of transceivers TRX as subscriber units via which communication links to mobile stations MS of individual subscribers are set up. Modern base transceiver stations BTS comprise up to 24 transceivers. In addition, each of the base transceiver stations BTS comprises a processor CP in which the signals of the individual transceivers TRX are combined and conducted to the base station controller on a common link V via the A_{bis} interface.

The base station controller BSC is connected to a mobile switching center MSC which represents the interface to other networks. The mobile switching center MSC and the base station controllers BSC are controlled by an operations and maintenance center OMC.

Between the base transceiver station BTS and the base station controller BSC, signaling messages are exchanged in accordance with an LAPD link access protocol. These signaling messages comprise, on the one hand, signaling which is required for maintaining a communication link such as, for example, Establish Request, Release Request, Channel Activation, Handover Detection or Mode Modify Request messages and, on the other hand, signaling messages which relate to measuring procedures. These signaling messages relating to measuring procedures are not absolutely necessary for maintaining a communication link. They can be transmitted at arbitrary times in the calls.

As the number of transceivers TRX increases in a base transceiver station BTS, the utilization of the common link V between base transceiver station BTS and base station controller BSC increases. The utilization of the processor CP increases by the same amount. Thus, the capacity of the processor CP and of the common link V limits the number of communication links possible.

In the method, signaling messages relating to measuring procedures are interrupted if required due to the utilization, in order to utilize the capacity of the common link V and of the processor CP as well as possible. For this purpose, the signaling messages which are exchanged between a transceiver TRX and one of the base station controllers BSC are divided into a first class of signaling messages and into a second class of signaling messages. The first class of signaling messages contains signaling messages which are important for maintaining a communication link, for example Establish Request, Release Request, Channel Activation, Handover Detection or Mode Modify Request messages. The second class of signaling messages contains signaling messages which relate to measuring procedures, for example Measurement Result messages.

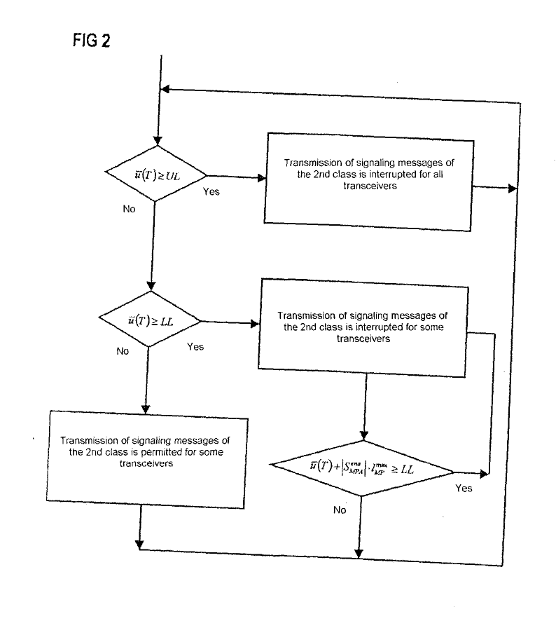

In the processor CP, a utilization \overline{u}(T) is measured by measuring the processor load over a predetermined period of time T. The measurement can also be done by measuring the idle processor task. In this process, the proportion of time in which the processor is idle is determined. If the measured utilization \overline{u}(T) exceeds a first threshold UL, the transmission of signaling messages of the second class is interrupted for all transceivers TRX (see FIG. 2). As a result, the measured utilization \overline{u}(T) drops.

If the measured utilization \overline{u}(T) is lower than the first threshold UL but greater than or equal to a second threshold LL, the transmission of signaling messages of the second class is interrupted for some transceivers TRX. For this purpose, the transmission of signaling messages of the second class is progressively interrupted for one transceiver in each case as long as the measured utilization \overline{u}(T) plus an estimated utilization Us exceeds the second threshold LL for the transmission of signaling messages assigned to the second class. This ensures that the measured utilization \overline{u}(T) drops below the second threshold LL by such an amount that the utilization \overline{u}(T) then currently measured does not exceed the second threshold LL even in the case where all transceivers simultaneously transmit signaling messages of the second class.

If the measured utilization \overline{u}(T) drops below the second threshold LL, the transmission of signaling messages of the second class is permitted for some transceivers.

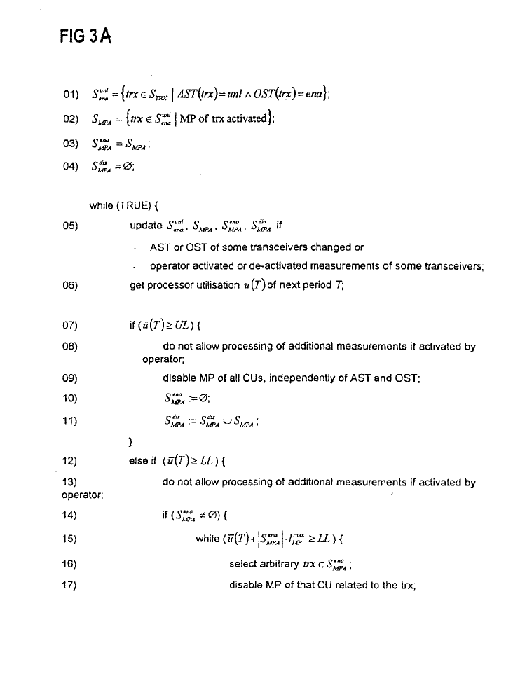

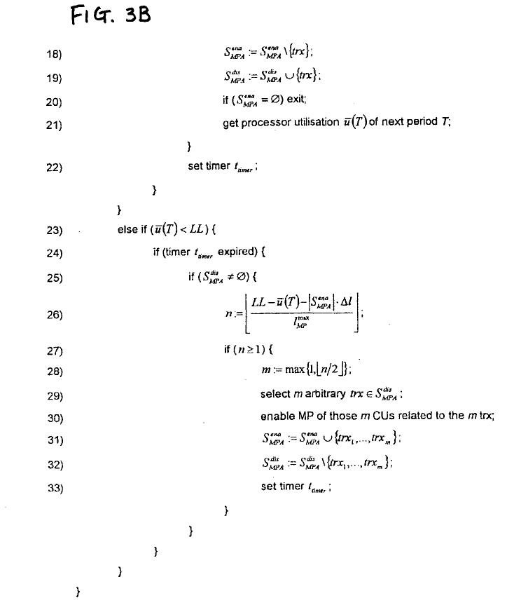

In the text which follows, an exemplary embodiment of the algorithm used is described with reference to FIGS. 3A-3C. In FIGS. 3A-3C, the algorithm is shown in a pseudo programming language.

In lines 01 to 04, the sets used are first initialized. The set Sₑₙₐ^{unl} contains all transceivers TRX from the set of transceivers S_{TRX} for which an administrative state AST (TRX) has the value UNL, that is to say the corresponding transceiver is permitted (unlocked) by an operator of the radio communication system, and for which an operative state OST(TRX) has the value ENA, that is to say the transceiver TRX is enabled.

S_{MPA} is the set of transceivers TRX from the set of unlocked and enabled transceivers Sₑₙₐ^{unl} for which the measuring procedure MP of the transceiver TRX is activated by the operations and maintenance center.

The set S_{MPA}^{ena} is the set of all transceivers TRX from the set S_{MPA} for which the measuring procedure of the transceiver TRX in the base transceiver station is enabled. To start the algorithm, all measuring procedures MP activated by the operator are kept enabled by the base transceiver station so that Sₑₙₐ^{unl}=S_{MPA} holds true.

The set S_{MPA}^{dis} is the set of all transceivers from the set S_{MPA} for which the measuring procedure of the transceiver is disabled by the base transceiver station. When the algorithm starts, the set S_{MPA}^{dis} is empty since no measuring procedures are disabled by the base transceiver station.

During the process, the sets Sₑₙₐ^{unl}, S_{MPA}, S_{MPA}^{ena}, S_{MPA}^{dis} are regularly updated if the administrative state AST or the operative state OST of one of the transceivers changes or if measuring procedures are activated or deactivated for transceivers by the operator. For example, a transceiver TRX which assumes an unlocked and enabled state is added to set Sₑₙₐ^{unl}. If, in contrast, a transceiver TRX is locked or disabled, the transceiver TRX is removed from the set Sₑₙₐ^{unl} (see line 05).

The measured utilization \overline{u}(T) of the processor CP is determined for the next predetermined period T (see line 06).

If the measured utilization \overline{u}(T) is greater than or equal to the first threshold UL, no further measuring procedures are permitted which are recently activated by the operator, and the measuring procedures for all transceivers TRX are immediately interrupted irrespective of their administrative and operative state. This interruption takes place in the base transceiver station BTS. The set Sₑₙₐ^{unl} thus becomes empty. The set S_{MPA}^{dis} is obtained as the union offsets of the previous set S_{MPA}^{dis} with the set S_{MPA.} In other words, all measuring procedures activated by the operator are disabled (see lines 07 to 11).

If the measured utilization \overline{u}(T) is lower than the first threshold UL and greater than or equal to the second threshold LL, no additional measuring procedures are unlocked which are activated by the operator. Furthermore, the measuring procedures are disabled for some transceivers TRX if the set Sₑₙₐ^{unl} is not empty. For this purpose, if the sum of the measured utilization \overline{u}(T) and the product of the number of elements of the set S_{MPA}^{ena} and a maximum utilization by the signaling messages of a measuring procedure l_{MP}^{max} is greater than or equal to the second threshold LL, a transceiver TRX is arbitrarily selected from the set S_{MPA}^{ena} for which the measuring procedure is disabled (see lines 12 to 17). Following that, the transceiver is removed from the set Sₑₙₐ^{unl} and added to the set S_{MPA}^{dis}. As soon as the set S_{MPA}^{ena} is empty, this loop is exited (see lines 18 to 20). If not, the measured utilization \overline{u}(T) for the next period T is determined in the processor CP (see line 21).

A timer tₜᵢₘₑᵣ is started (see line 22).

If the measured utilization \overline{u}(T) is lower than the second threshold LL, the measuring procedures of as many transceivers TRX as possible are enabled. For this purpose, a number n of the maximum additionally possible enabled transceivers TRX is determined as soon as the timer has elapsed and if the set S_{MPA}^{dis} is not empty (see lines 23 to 26). The number n is calculated as the smallest integral number and the difference between the second threshold LL and the measured utilization \overline{u}(T) minus the product of the number of elements of the set S_{MPA}^{ena} and a parameter Δ1 divided by the utilization l_{MP}^{max} caused by the signaling message of a measuring procedure. The parameter Δ1 is selected between 0 and l_{MP}^{max} and represents a safety margin between the maximum utilization to be expected and the second threshold LL.

Following this, a number m is determined which is equal to 1 or to the largest integral number which is less than or equal to n/2. m transceivers TRX are arbitrarily selected from the set S_{MPA}^{dis}. The measuring procedures for these m transceivers TRX are enabled by the base transceiver station. After that, the corresponding transceivers are added to the set Sₑₙₐ^{unl} and removed from the set S_{MPA}^{dis}. The timer tₜᵢₘₑᵣ is started again (see lines 28 to 33).

The period T over which the measured utilization \overline{u}(T) is measured should be longer than the duration of a time slot, that is to say 480 msec, in order to obtain a mean value and in order to compensate for the influence of individual high utilizations. The parameter T is selected within the range of between 5×480 msec and 20×480 msec, preferably 10×480 msec.

The duration of the timer tₜᵢₘₑᵣ should be sufficiently longer than the period T in order to obtain a reliable mean value on the basis of a plurality of measurements. tₜᵢₘₑᵣ is selected within the range of between 5×T and 20×T, preferably 10=T.

The first threshold UL and the second threshold LL are preferably selected in such a manner that the second threshold LL is at the optimum operating point of the processor CP with regard to maximum throughput. This is mostly the case in the range between 50% and 70% and preferably at 50%. The first threshold UL should preferably be higher than the second threshold LL by 20% with a fluctuation in utilization of between 10,000 and 36,000 Busy Hour Call Attempts (BHCA).

The maximum utilization for the transmission of a signaling message for a measuring procedure l_{MP}^{max} can be estimated with the assumption that all transceivers are simultaneously transmitting signaling messages for measuring procedures. In this case, a value of 3.2% is obtained. As an alternative, l_{MP}^{max} can be estimated by using various traffic models as a basis. This results in values of between 1 and 3% depending on the traffic model. These numbers are obtained for the case where the transceiver is configured in full-rate mode. The values are doubled in the case where the transceiver is configured in half-rate mode.

The parameter Δ1 is selected between 0 and l_{MP}^{max}. A value of Δ1=1% is preferably selected.

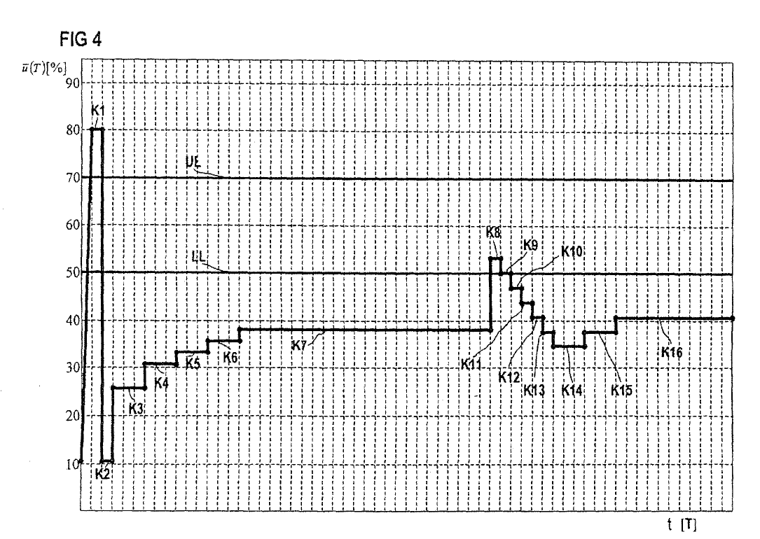

FIG. 4 shows the variation with time of the utilization of the processor CP which is regulated in accordance with the method, 70% having been assumed for the first threshold UL, 50% for the second threshold LL and 1% for the parameter Δ1 and 24 transceivers being provided. The measured utilization \overline{u}(T) is plotted against time T in units of T. T is the period over which the utilization is measured. At the beginning, the measuring procedures are enabled for all 24 transceivers. This results in a utilization \overline{u}(T) of 80%, that is to say the first threshold UL is exceeded (see area K1 of the curve). Following this, the measuring procedures are interrupted for the 24 transceivers so that the utilization drops back to 10% (see area K2). After that, the measuring procedures are enabled step by step for 11 transceivers (see areas K3, K4, K5, K6, K7). Initially, 6 transceivers and then two and then 3×1 transceiver are added. The steps take place in time intervals corresponding to the timer duration tₜᵢₘₑᵣ . After that, a relatively stable state has been produced (see area K7) which persists for a relatively long period until the traffic flow increases, for example from 10,000 BHCA to 30,000 BHCA. This results in a utilization of over 50%, that is to say above the second threshold LL (see area K8). Now, the measuring procedures are disabled step by step for 6 transceivers until the condition for disabling measuring procedures is met (see areas K9 to K14). Since the utilization is stable over a particular time (see area K14), the measuring procedures for two transceivers are again enabled step by step (see areas K15 and K16). After that, the measuring procedures for seven transceivers are enabled by the base transceiver station.

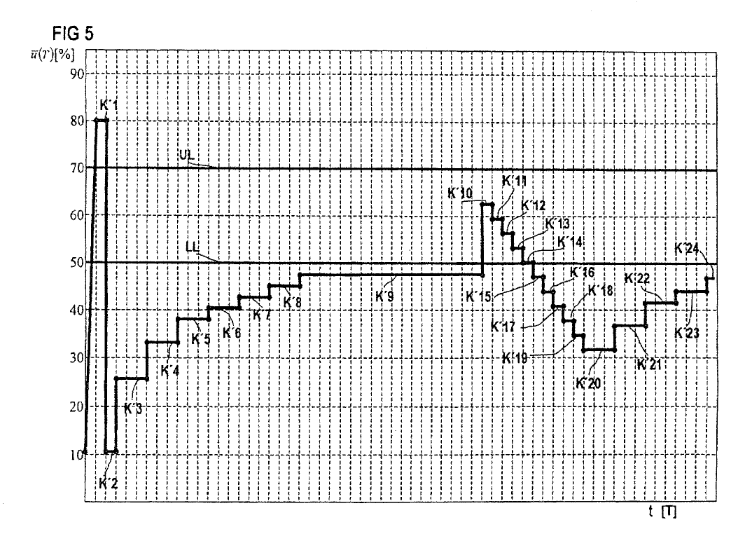

FIG. 5 shows the variation with time of the utilization \overline{u}(T) as a function of time t in units T for the same system, the difference being that the parameter Δ1=0% is set. At the beginning, the measuring procedures are enabled for all 24 transceivers. This results in a utilization \overline{u}(T) of 80%, that is to say the first threshold UL is exceeded (see area K′1 of the curve). Following this, the measuring procedures are interrupted for the 24 transceivers so that the utilization drops back to 10% (see area K′2). After the measuring procedures of all transceivers have been disabled, the measuring procedures are enabled again step by step for 15 transceivers in this case (see areas K′3 to K′9). The interval between the stable state then reached and the second threshold LL has dropped to a few % because of Δ1=0%. The increase in traffic loading from 10,000 BHCA to 30,000 BHCA has the effect, therefore, that the utilization \overline{u}(T) exceeds the second threshold LL by more than 10% (see area K′10). Correspondingly, the measuring procedures are disabled step by step for 10 transceivers (see areas K′1 1 to K′20). After a stable value has been reached (see area K′20), the measuring procedures for a plurality of transceivers are enabled again step by step (see K′21 to K′24).

The invention has been described in detail with particular reference to preferred embodiments thereof and examples, but it will be understood that variations and modifications can be effected within the spirit and scope of the invention.

1. A method for transmitting signaling messages between a first network unit and a second network unit of a communication system, comprising:
providing a plurality of subscriber units which transmit and receive signaling messages, the plurality of subscriber units being provided in the first network unit;
dividing the signaling messages of the subscriber units into a first class of signaling messages and a second class of signaling messages;
transmitting the signaling messages between the first network unit and the second network unit via a common link; and,
interrupting transmission of signaling messages assigned to the second class for all subscriber units when a measured utilization of the common link exceeds a first threshold.

2. The method as claimed in claim 1, wherein the measured utilization is measured over a period of time at a processor of the first network unit which controls the common link between the first network unit and the second network unit.

3. The method as claimed in claim 1, wherein if the measured utilization of the common link drops below the first threshold and exceeds a second threshold which is lower than the first threshold, the transmission of signaling messages assigned to the second class is interrupted for some of the subscriber units.

4. The method as claimed in claim 1, wherein
the method further comprises estimating a utilization of the common link required to transmit signaling messages assigned to the second class, and
if the measured utilization exceeds a second threshold, which is lower than the first threshold, then the transmission of signaling messages assigned to the second class is progressively interrupted for additional subscriber units until the measured utilization plus the utilization estimated to transmit signaling messages assigned to the second class drops below the second threshold.

5. The method as claimed in claim 3, wherein if the measured utilization drops below the second threshold, the transmission of signaling messages assigned to the second class is resumed for a portion of subscriber units for which the transmission of signaling messages assigned to the second class was interrupted.

6. The method as claimed in claim 5, wherein
when the measured utilization drops below the second threshold, the method further comprises determining the difference between the second threshold and the measured utilization, and
the number of subscriber units for which the transmission of signaling messages assigned to the second class is resumed is determined in dependence on the difference between the second threshold and the measured utilization.

7. The method as claimed in claim 1, wherein the signaling messages assigned to the second class comprise signaling messages for measuring procedures.

8. The method as claimed in claim 2, wherein if the measured utilization of the common link drops below the first threshold and exceeds a second threshold which is lower than the first threshold, the transmission of signaling messages assigned to the second class is interrupted for some of the subscriber units.

9. The method as claimed in claim 8, wherein
the method further comprises estimating a utilization of the common link required to transmit signaling messages assigned to the second class, and
if the measured utilization exceeds the second threshold, then the transmission of signaling messages assigned to the second class is progressively interrupted for additional subscriber units until the measured utilization plus the utilization estimated to transmit signaling messages assigned to the second class drops below the second threshold.

10. The method as claimed in claim 9, wherein if the measured utilization drops below the second threshold, the transmission of signaling messages assigned to the second class is resumed for a portion of subscriber units for which the transmission of signaling messages assigned to the second class was interrupted.

11. The method as claimed in claim 10, wherein
when the measured utilization drops below the second threshold, the method further comprises determining the difference between the second threshold and the measured utilization, and
the number of subscriber units, for which the transmission of signaling messages assigned to the second class is resumed, is determined in dependence on the difference between the second threshold and the measured utilization.

12. The method as claimed in claim 11, wherein the signaling messages assigned to the second class comprise signaling messages for measuring procedures.

13. A radio communication system comprising:
a base transceiver station;
a common link; and
a base station controller to transmit and receive first and second class signaling messages with the base transceiver station via the common link such that transmission of second class signaling messages is interrupted when a measured utilization of the common link exceeds a first threshold.

14. A base transceiver station system comprising:
a base transceiver station; and
a base station controller to transmit and receive first and second class signaling messages with the base transceiver station via a common link such that transmission of second class signaling messages is interrupted when a measured utilization of the common link exceeds a first threshold.
